(19) United States
(12) Patent Application Publication
(10) Pub. No.: US 2006/0059293 A1
(43) Pub. Date: Mar. 16, 2006

(54) Universal serial bus switching hub

(76) Inventors: Henry Wurzburg, Austin, TX (US); James E. Bowles, Austin, TX (US); Robert E. Hollingsworth, Smithtown, NY (US); Mark R. Bohm, Village of Bear Creek, TX (US); Drew J. Dutton, Austin, TX (US)

Correspondence Address: MEYERTONS, HOOD, KIVLIN, KOWERT & GOETZEL, P.C., P.O. BOX 398, AUSTIN, TX, 78767-0398, US

(21) Appl. No.: 10/940,406

(22) Filed: Sep. 14, 2004

(51) Int. Cl. G06F 13/20

(52) U.S. Cl. 710/313

(57) ABSTRACT

In various embodiments, a USB switching hub may switch between a first configuration and a second configuration to switch access between two or more upstream ports on the hub to at least a subset of downstream ports on the hub. In some embodiments, the hub may include a downstream routing controller to switch between the first configuration and the second configuration. In some embodiments, configurations (e.g., hardwired in the USB switching hub) may be switched as determined by logic on the USB switching hub.

### BACKGROUND OF THE INVENTION

1. Field of the Invention

The present invention relates generally to peripheral device hubs and, more specifically, to Universal Serial Bus (USB) switching hubs.

2. Description of the Related Art

The Universal Serial Bus (USB) allows coupling of peripheral devices to a computer system. USB is a serial cable bus for data exchange between a host computer and a wide range of simultaneously accessible devices. The bus allows peripherals to be attached, configured, used, and detached while the host is in operation. For example, USB printers, scanners, digital cameras, storage devices, card readers, etc. may communicate with a host computer system over USB. USB based systems may require that a USB host controller be present in the host system, and that the operating system (OS) of the host system support USB and USB Mass Storage Class Devices.

USB devices may communicate over the USB bus at low-speed (LS), full-speed (FS), or high-speed (HS). A connection between the USB device and the host may include four wires (a power line, a ground line, and a pair of data lines (D+ and D−). When a USB device connects to the host, the USB device may first pull a D+ line high (the D− line if the device is a low speed device) using a pull up resistor on the D+ line. The host may respond by resetting the USB device. If the USB device is a high-speed USB device, the USB device may “chirp” by driving the D− line high during the reset. The host may respond to the “chirp” by alternately driving the D+ and D− lines high. The USB device may then electronically remove the pull up resistor and continue communicating at high speed. When disconnecting, full-speed devices may remove the pull up resistor from the D+ line (i.e., “tri-state” the line), while high-speed USB devices may tri-state both the D+ and D− lines.

A USB hub may be coupled to a USB host controller to allow multiple USB devices to be coupled to the host system through the USB host controller. In addition, other USB hubs may be coupled to the USB hub to provide additional USB device connections to the USB host controller.

Some dual role peripheral devices may include a slave controller and be capable of communicating with other peripheral devices coupled to them. For example, a dual role USB printer may be able to communicate directly with a USB camera to print pictures from the USB camera. The dual role USB printer may also be accessible (e.g., by a computer system) as a slave peripheral device. If a computer system and dual role peripheral device need to alternately access a peripheral device, the peripheral device may need to be unplugged from one device and coupled to the other. Prior art device switches may not work for high-speed peripheral devices. For example, mechanical switches may introduce too much capacitance or inductance to work with high-speed peripheral devices. High-speed peripheral devices also typically require smooth impedance to prevent ringing (mechanical switches introduce irregularities in the impedance that may cause ringing).

### SUMMARY OF THE INVENTION

In various embodiments, a USB switching hub may control access between two or more upstream ports on the USB switching hub and at least a subset of downstream ports on the USB switching hub. The USB switching hub may electronically switch between different configurations (e.g., hardwired or software implemented configurations) for access between the two or more upstream ports and the downstream ports. In an embodiment with two upstream ports and three downstream ports, a USB switching hub may switch between multiple configurations. For example, in a first configuration, the first upstream port may be allowed access to the first two downstream ports and the second upstream port may be allowed access to the third downstream port. In a second configuration, the first upstream port may be allowed to access the third downstream port while the second upstream port may be allowed to access the first two downstream ports. Other configurations are also possible (e.g., in one configuration neither upstream port may be allowed to access any downstream port). The USB switching hub, after receiving a control signal (e.g., from a computer, a different attached device, a person, a sensor, etc.), may switch between the first configuration and the second configuration (or another configuration). The control signal may be generated internal to the USB switching hub (e.g., by logic internal to the USB switching hub). In some embodiments, the USB switching hub may not receive a control signal before switching configurations.

In some embodiments, a computer system and a dual role peripheral device (e.g., a dual role USB printer or dual role USB Digital Versatile Disc (DVD) read/write drive, among others) may be coupled to upstream ports of a USB switching hub. Other devices and/or systems (e.g., another computer system) may be coupled to the upstream ports. The dual role peripheral device may interface with other peripheral devices (e.g., downstream peripheral devices) through its host controller and/or may interface with other devices (such as the computer system) as a peripheral device itself.

In some embodiments, the upstream ports may be coupled to a downstream routing controller through one or more hub controllers. The downstream routing controller may switch between different configurations for the two or more upstream ports and the downstream ports (e.g., when triggered by a control signal). In some embodiments, the downstream routing controller may be coupled to the downstream ports through transaction translator circuitry. In some embodiments, the peripheral devices (as well as the dual role peripheral device) may be coupled through interfaces (e.g., a USB Physical Layer (PHY) interface, USB Transceiver Macrocell Interface (UTMI), or UTMI plus low pin interface (ULPI), among others) to the downstream ports. In some embodiments, configurations (e.g., hardwired in the USB switching hub) may be switched as determined by logic on the USB switching hub. Other configuration implementations are also contemplated.

### BRIEF DESCRIPTION OF THE DRAWINGS

A better understanding of the present invention may be obtained when the following detailed description is considered in conjunction with the following drawings, in which:

FIG. 1 illustrates a USB switching hub, according to an embodiment;

FIG. 2 illustrates a computer system coupled to a USB switching hub, according to an embodiment;

FIG. 3 illustrates a computer system and a dual role peripheral device coupled to a USB switching hub, according to an embodiment;

FIGS. 4a and 4b illustrate two configurations of the USB switching hub, according to an embodiment;

FIGS. 5a, 5b, and 5c illustrate additional configurations of the USB switching hub, according to an embodiment;

FIG. 6 illustrates unified functions within the USB switching hub, according to an embodiment; and

FIG. 7 illustrates a method for switching access to a downstream port between two upstream ports, according to an embodiment.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims. Note, the headings are for organizational purposes only and are not meant to be used to limit or interpret the description or claims. Furthermore, note that the word “may” is used throughout this application in a permissive sense (e.g., having the potential to or being able to in some embodiments), not a mandatory sense (i.e., must). The term “include”, and derivations thereof, mean “including, but not limited to”. The term “coupled” means “directly or indirectly connected”.

### DETAILED DESCRIPTION OF EMBODIMENTS OF THE INVENTION

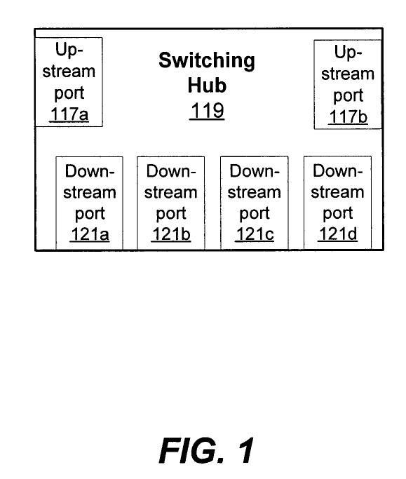

FIG. 1 illustrates an embodiment of a USB switching hub. In various embodiments, a USB switching hub 119 may control access between two or more upstream ports 117 on the USB switching hub 119 and at least a subset of downstream ports 121 on the USB switching hub 119. In some embodiments, the USB switching hub 119 may switch between configurations (e.g., hardwired or software implemented configurations) for access between the two or more upstream ports 117 and the downstream ports 121. For example, in an embodiment with two upstream ports 117 and four downstream ports 121, a USB switching hub 119 may switch between multiple configurations. In a first configuration, a first upstream port 117a may be allowed access to the first three downstream ports (121a, 121b, and 121c) and the second upstream port 117b may be allowed access to the fourth downstream port 121d. In a second configuration, the first upstream port 117a may be allowed to access the fourth downstream port 121d while the second upstream port 117b may be allowed to access the first three downstream ports (121a, 121b, and 121c). Other configurations are also possible (e.g., in one configuration neither upstream port 117 may be allowed to access any downstream port 121). In some embodiments, a USB switching hub 119, after receiving a control signal (e.g., from a computer, a different attached device, a person, a sensor, a logic internal to the USB switching hub 119, etc.), may switch between the first configuration and the second configuration (or another configuration). In some embodiments, the USB switching hub 119 may not receive a control signal before switching configurations.

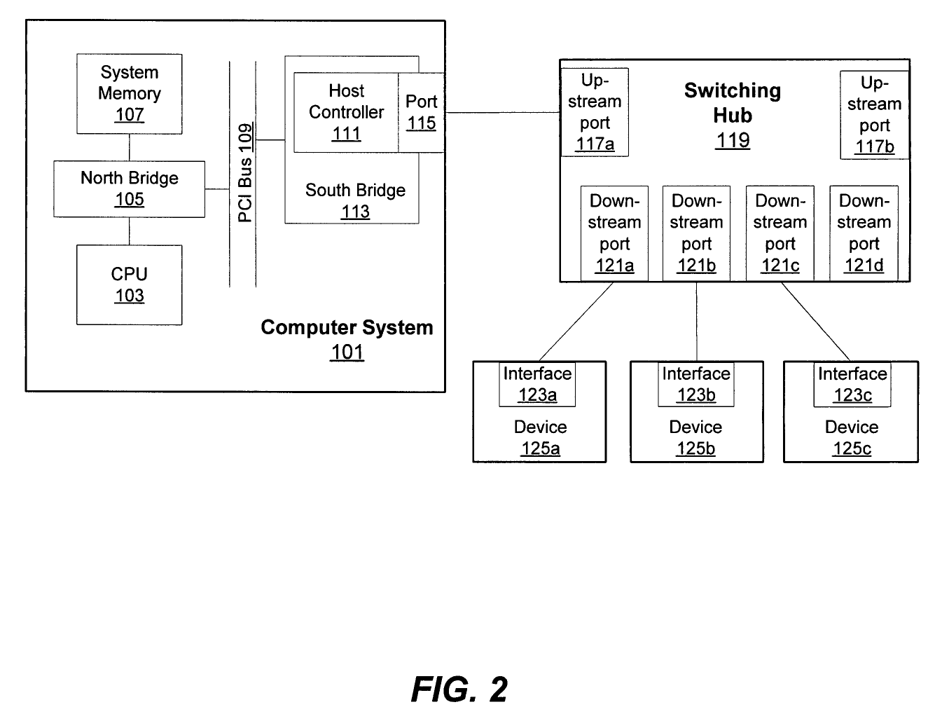

FIG. 2 illustrates an embodiment of a computer system 101 coupled to a USB switching hub 119. In some embodiments, a computer system 101 (e.g., a personal computer (PC), laptop, server, etc.) may access multiple peripheral devices 125 coupled to a USB switching hub 119. The computer system 101 may couple to the USB switching hub 119 through an upstream port 117. The computer system 101 may receive and transmit signals, e.g., USB signals, through a host controller 111 coupled to a device port 115. The host controller 111, coupled to a south bridge 113, may be coupled to other computer components (e.g., the north bridge 105, central processing unit (CPU) 103, and system memory 107) through the peripheral component interconnect (PCI) bus 109.

In some embodiments, the USB switching hub 119 may have multiple downstream ports 121 for coupling to multiple peripheral devices 125. Peripheral devices 125 may include USB printers, scanners, digital cameras, digital camera docks, consumer audio/video, storage devices, and card readers, among others. In some embodiments the peripheral devices 125 may couple to the USB switching hub 119 through an interface 123. In some embodiments, the interface 123 may be a PHY interface. Other interfaces may also be used (e.g., UTMI or ULPI). The upstream ports 117 and downstream ports 121 may also have interfaces.

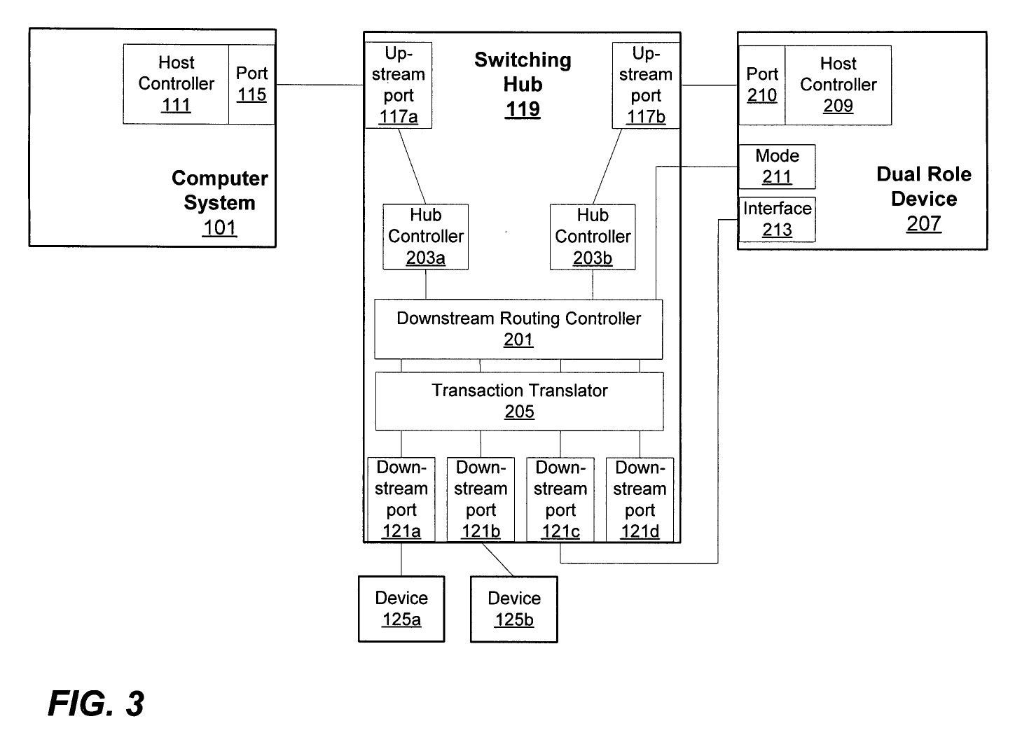

FIG. 3 illustrates an embodiment of two upstream devices (e.g., a computer system 101 and a dual role peripheral device 207) coupled to the USB switching hub 119. In some embodiments, the USB switching hub 119 may include a downstream routing controller 201, coupled to one or more hub controllers 203 (e.g., hub controllers 203a and 203b). The downstream routing controller 201 may also be coupled to transaction translator circuitry 205. The transaction translator 205 may be electronically coupled to downstream ports 121. In some embodiments, the downstream routing controller 201 may switch between two or more configurations. Configurations may be implemented by the downstream routing controller 201 routing communications between the upstream ports 117 and the downstream ports 121 while the communications are in the digital domain (as a result of the interfaces to/from the USB switching hub 119). In some embodiments, configurations (e.g., hardwired in the USB switching hub) may be switched as determined by logic on the USB switching hub. Other configuration implementations are also contemplated.

In some embodiments, a dual role peripheral device 207 may include a dual role USB printer or dual role USB Digital Versatile Disc (DVD) read/write drive, among others. In some embodiments, the dual role peripheral device 207 may be coupled to an upstream port (e.g., upstream port 117b) of the USB switching hub 119 through device port 210. The dual role peripheral device 207 may interface through the upstream port 117b with other peripheral devices (downstream peripheral devices) coupled to the USB switching hub 119 (e.g., using a host controller 209 on the dual role peripheral device 207). The dual role peripheral device 207 may also interface with other upstream devices (such as the computer system 101) through a slave controller. For example, the dual role peripheral device 207 may be coupled to the USB switching hub 119 as a slave peripheral device (e.g., through a downstream port 121c). In some embodiments, the dual role peripheral device 207, coupled to the USB switching hub, may simultaneously act as a host to one or more peripheral devices and/or as slave peripheral device to a separate host.

In some embodiments, the dual role peripheral device 207 may have an embedded host controller application to operate as a standalone system (e.g., to communicate with another peripheral device, such as a digital camera, without PC intervention). For example, a dual role USB printer may print pictures directly from a digital camera, coupled to a downstream port 121 on the USB switching hub 119, without PC intervention. In some embodiments, the USB switching hub 119 may alternately allow the computer system 101 or the dual role peripheral device 207 to access one or more downstream devices (e.g., by switching between one or more configurations).

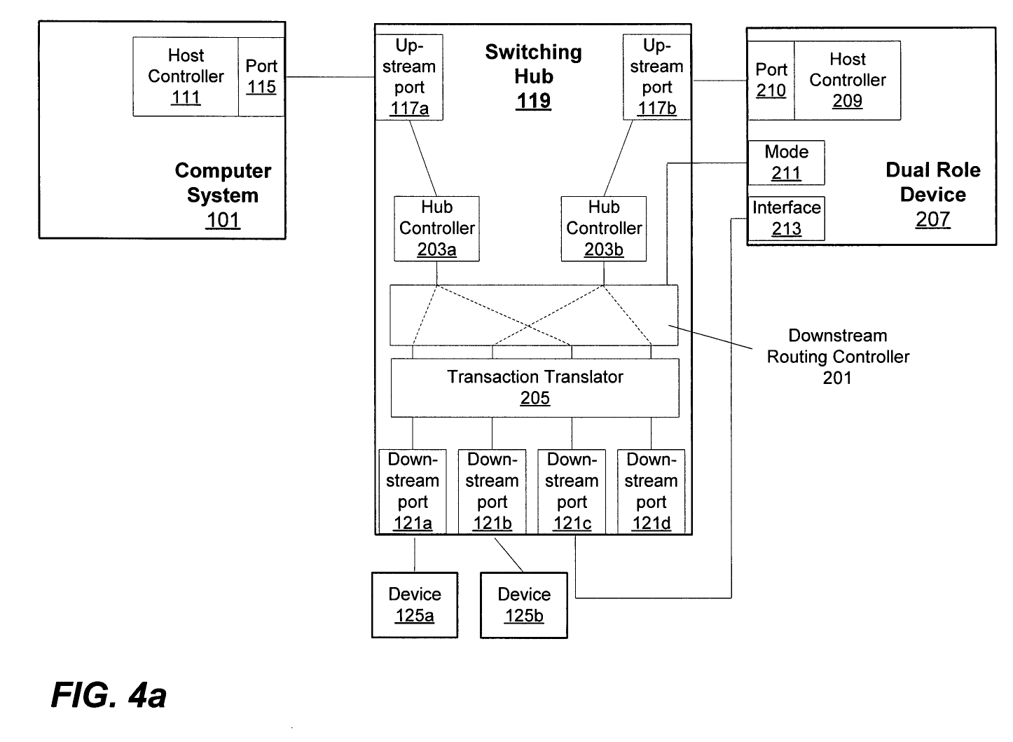

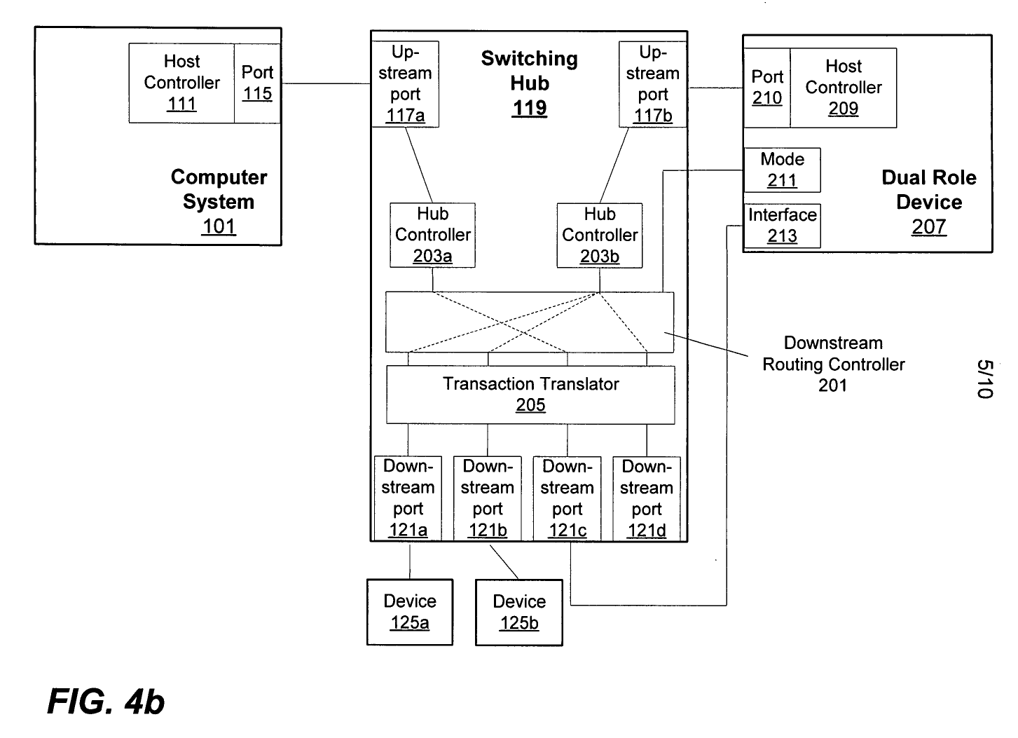

FIG. 4a illustrates an embodiment of a computer system electronically coupled to multiple peripheral devices. In some embodiments, the USB switching hub 119 may act like a switch coupling multiple internal “hubs” that may share one or more downstream ports. For example, each potential configuration of the USB switching hub may represent an internal “hub”. In some embodiments, when the computer system 101 is accessing a peripheral device 125 (e.g., peripheral device 125a) coupled to the USB switching hub 119, communications to/from the peripheral device may be processed through a first “hub” comprised of first upstream port 117a, hub controller 203a, transaction translator 205, and at least a subset of the downstream ports 121. A second “hub” may be comprised of a second upstream port 117b, hub controller 203b, transaction translator 205, and at least a subset of the downstream ports 121. In one configuration, the computer system 101 may connect to downstream ports 121 a and 121c (through the first “hub”), and the dual role peripheral device 207 may connect to downstream ports 121b and 121d (through the second “hub”) (as seen in FIG. 4b). Other configurations are also contemplated. In some embodiments, configuration profiles designating which downstream devices to couple to each upstream port may be hardwired or implemented by software. For example, if implemented by software, configuration profiles for each upstream port (and/or upstream device) may be stored on a memory accessible to the USB switching hub 119.

In some embodiments, the computer system 101 and the dual role peripheral device 125 may communicate through the USB switching hub 119 simultaneously with separate downstream devices. For example, while the computer system 101 communicates with device 125a (e.g., through the first “hub”), the dual role peripheral device 207 may communicate with device 125b (e.g., through the second “hub”). In some embodiments, while the peripheral device 125a is being accessed through the first “hub”, a different upstream device may not be able to access peripheral device 125a (e.g., dual role peripheral device 207 may not be able to access peripheral device 125a while peripheral device 125a is being used by computer system 101). In some embodiments, a signal (e.g., from an external control block) may trigger the downstream routing controller 201 to switch access for a subset of downstream ports 121 (e.g., downstream port 121a and/or 121c) on the first “hub” to the second “hub” (i.e., switch configurations).

In some embodiments, the dual role peripheral device 207 may send a control signal to the USB switching hub 119. The USB switching hub may then switch configurations to connect one or more downstream ports to the dual role peripheral device. For example, when a user presses a button on a dual role peripheral device 207 (e.g., a dual role printer), a signal may be sent through mode 211 to the downstream routing controller 201 to switch access of the device 125a from the computer system 101 to the dual role peripheral device 207 (i.e., to switch to a second configuration as seen in FIG. 4b). The computer system 101 may continue to communicate with downstream port 121c (and/or other downstream ports as determined by the second configuration).

In some embodiments, when activity is no longer detected between the dual role peripheral device 207 and a downstream port (e.g., if the dual role peripheral device 207 is turned off), the downstream routing controller 201 may switch access of the downstream port to the computer system 101 (i.e., switch to a different configuration). In some embodiments, the downstream routing controller 201 may switch access of the downstream port to a different upstream device. In some embodiments, instead of detecting inactivity, a signal from the dual role peripheral device 207 may signal the USB switching hub 119 to switch. Other signals and/or logic may also be used in determining when to switch configurations.

In some embodiments, configurations may be software implemented. In some embodiments, a microprocessor coupled to or comprised in the downstream routing controller 201 may dynamically determine, e.g., using a dynamic configuration profile, which downstream ports to electrically couple to each upstream port. For example, the microprocessor may read a stored configuration profile and attempt to connect upstream ports to downstream ports according to the configuration profile. The configuration profiles may be stored on a memory (e.g., an Electronically Erasable Programmable Read-Only Memory (EEPROM)) coupled to the USB switching hub 119. In some embodiments, hub controllers on the USB switching hub may have access to the configuration profiles.

In some embodiments, a priority logic may be used to switch configurations. Priority logic, or other logic used to grant access, may be internal or external to the USB switching hub 119. In some embodiments, a computer system 101 may be given priority over all of the downstream ports until an external control signal is sent from the dual role peripheral device 207 to switch access of one or more downstream ports to the dual role peripheral device 207. In some embodiments, different control signals may be sent to trigger different configurations (i.e., to switch access of different downstream ports to the dual role peripheral device 207).

In some embodiments, host negotiation logic may be used to determine which configuration to use. In some embodiments, a default configuration may be used until multiple upstream devices “request” access to the same downstream port. Host negotiation logic may be used to determine which configuration to use (i.e., which configuration gives a particular upstream port access to the “requested” downstream port).

In some embodiments, a microprocessor in the USB switching hub 119 may include a built in algorithm that auto detects downstream peripheral devices and determines how to connect the downstream peripheral devices. For example, instead of assigning a specific downstream port to an upstream port, a configuration profile may specify that the upstream port should have access to a digital camera if one is attached. The built in algorithm may auto-detect the digital camera when it is attached to one of the downstream ports and attach it to the appropriate upstream port (i.e., by switching to an appropriate configuration).

In some embodiments, when the downstream routing controller 201 switches configurations, and control of a downstream port is switched from the computer system 101 to the dual role peripheral device 207, a connection between the computer system 101 and the respective peripheral device 125 (coupled to the downstream port to be switched) may be terminated by the computer system 101. In some embodiments, communications between the downstream port to be switched and the computer system 101 may be terminated by the USB switching hub 119. The dual role peripheral device 207 may then connect to, enumerate, and communicate with the respective peripheral device 125 coupled to the switched downstream port.

Upstream devices may see downstream ports that they are not configured to attach to as unattached ports (i.e., active, but with no device connected). In some embodiments, if only a predetermined number of downstream ports is ever going to be attached to a particular upstream port (e.g., a number “x” ports), the upstream device may be signaled that the hub only has x ports. For example, if upstream port 117b is only going to be configured to attach to downstream ports 121c and 121d, a device attached to upstream port 117b may be signaled that the USB switching hub 119 is only a two port hub.

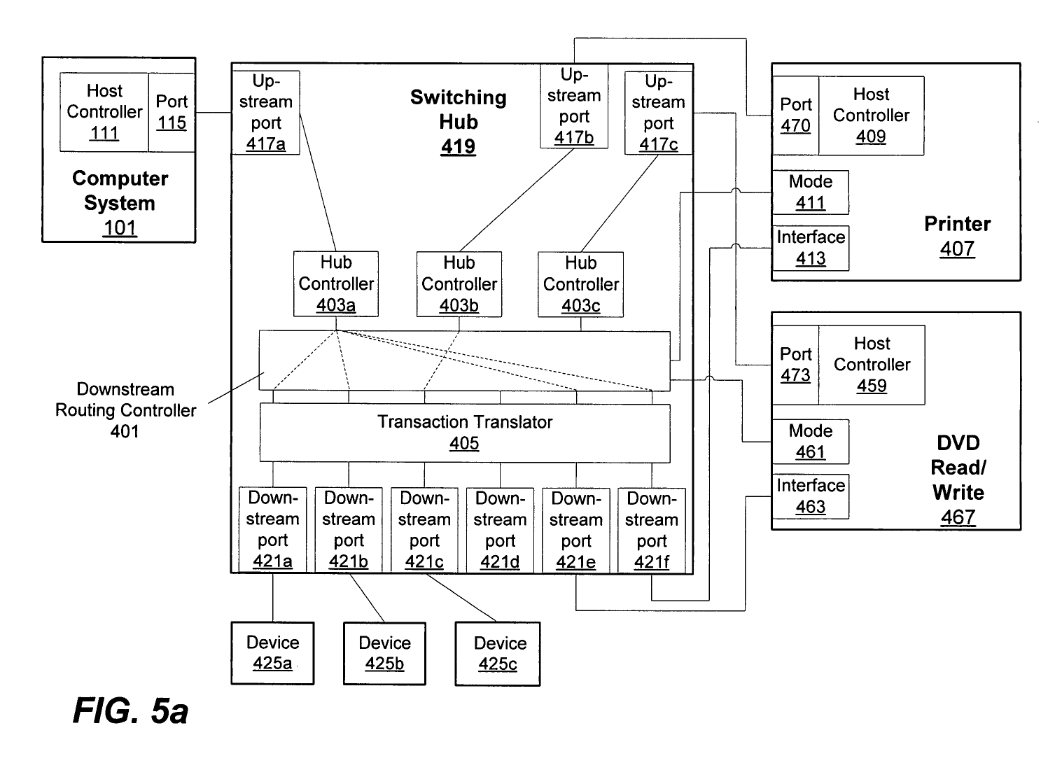

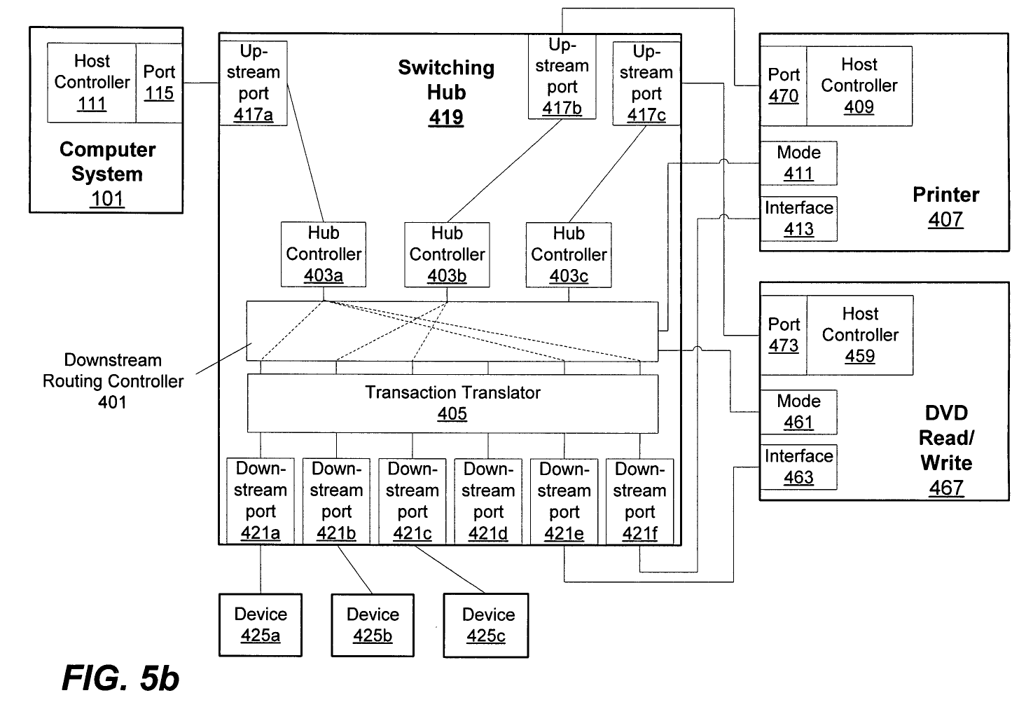

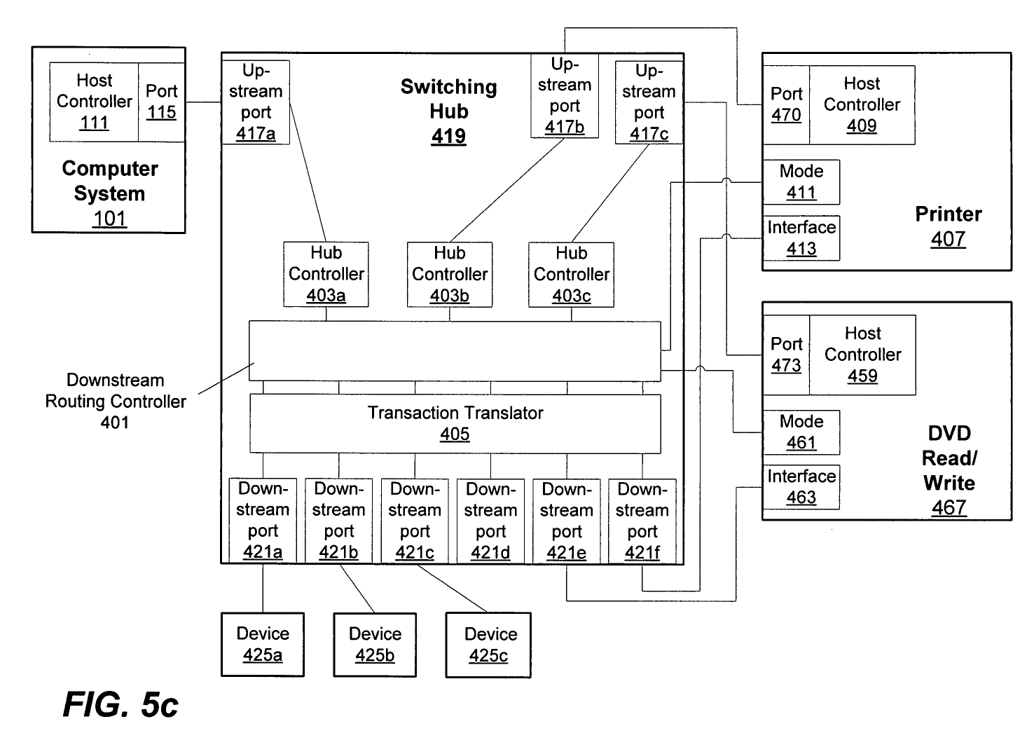

FIGS. 5a, 5b, and 5c illustrate various embodiments of a computer system 101 and two dual role peripheral devices coupled to the USB switching hub 419. In some embodiments, multiple dual role peripheral devices may be coupled to the USB switching hub 419. For example, a dual role printer 407 may be coupled to the USB switching hub 419 through upstream port 417b and a dual role DVD read/write drive 467 may be coupled to the USB switching hub 419 through upstream port 417c. Computer system 101 may be coupled to the USB switching hub 419 through upstream port 417a. Each of the upstream devices may be coupled to a respective hub controller 403, downstream routing controller 401, and transaction translator 405. Downstream routing controller 401 may configure communications between each of the upstream devices (i.e., the computer system 101, the dual role printer 407, or dual role DVD read/write drive 467) and at least a subset of the peripheral devices 425.

As seen in FIG. 5a, in one configuration profile, the computer system 101 may be connected to downstream ports 421a, 421b, 421e, and 421f. In an embodiment, the dual role printer 407 may be configured to access downstream port 421c, and the DVD read/write drive 467 may be configured not to access any downstream port 421. The dual role printer 407 may gain access (i.e., have the configuration switched to give it access) to downstream port 421b through several different methods. For example, a user may press a button on the dual role printer 407. A signal may then be sent through mode 411 to the downstream routing controller 401 in the USB switching hub 419. The downstream routing controller 401 may switch to the configuration seen in FIG. 5b (which allows the dual role printer 407 to access downstream port 421b). In some embodiments, if the dual role printer 407 is turned off or becomes inactive, the downstream routing controller 401 may switch access of downstream port 421b back to the computer system 101 (i.e., switch back to the previous configuration). As seen in FIG. 5c, in one configuration, none of the upstream ports may be allowed to access any of the downstream ports.

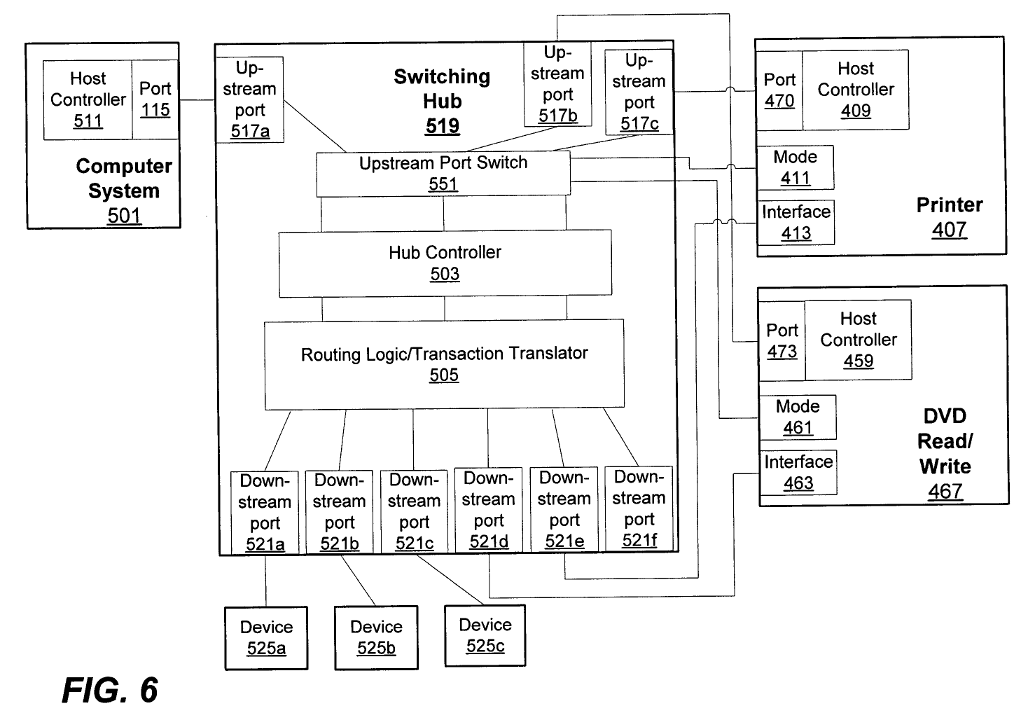

FIG. 6 illustrates an embodiment of unified functions within the USB switching hub. In some embodiments, instead of separate hub controllers, a unified hub controller 503 may be used. For example, instead of separate hub controllers handling communications for their respective upstream port, a unified hub controller may handle communications for each of the upstream ports. Similarly, a unified transaction translator 505 may be used for each respective upstream port. Also, as seen in FIG. 6, in some embodiments, an upstream port switch may be used. For example, the upstream port switch may implement various configurations instead of a downstream routing controller.

In some embodiments, transaction translator(s) in the USB switching hub (e.g., USB switching hub 419 or USB switching hub 519) may allow upstream ports to communicate at different communication speeds relative to the other upstream ports. For example, one upstream port may be coupled only to high speed devices and, therefore, communicate at high speed, while a separate upstream port may be coupled to only full speed devices and, therefore, communicate at full speed. In some embodiments, upstream ports may be able to communicate with different downstream ports at different speeds because of the transaction translators.

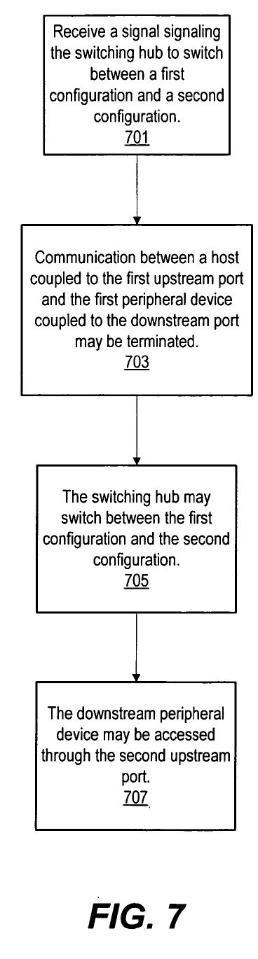

FIG. 7 shows an embodiment of a method for switching access to a downstream port between two upstream ports on the USB switching hub. It should be noted that in various embodiments of the methods described below, one or more of the elements described may be performed concurrently, in a different order than shown, or may be omitted entirely. Other additional elements may also be performed as desired.

At 701, the USB switching hub may receive a signal (e.g., an external control signal) signaling the USB switching hub to switch between a first configuration and a second configuration. For example, switching configurations may switch access of a first downstream port from a first upstream port to a second upstream port. In some embodiments, a user may press a button on a dual role peripheral device coupled to the USB switching hub, and the dual role peripheral device may send an external control signal to the USB switching hub to signal the USB switching hub to switch between one or more configurations. In some embodiments, the signal may be internal (e.g., generated by logic internal to the USB switching hub).

At 703, communication between a host coupled to the first upstream port and the first peripheral device coupled to the first downstream port may be terminated. In some embodiments, communication may be terminated for a subset of the downstream peripheral devices.

At 705, the USB switching hub may switch between the first configuration and the second configuration to give access of the first downstream port to the second upstream port. In some embodiments, the configuration switch may affect access for a subset of the downstream peripheral devices.

At 707, the downstream peripheral device coupled to the first downstream port may be accessed through the second upstream port by the host coupled to the second upstream port. In some embodiments, the second upstream port may communicate with a subset of the downstream peripheral devices. For example, the host may enumerate and then communicate with the switched multiple downstream devices. In some embodiments, access between the first upstream port and a second downstream port may continue.

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. An apparatus, comprising:
a USB switching hub, wherein the USB switching hub comprises at least two upstream ports and a plurality of downstream ports;
wherein the USB switching hub is configured to electronically switch between two or more configurations of access between the upstream ports and at least a subset of the plurality of downstream ports.

2. The apparatus of claim 1, wherein the USB switching hub comprises:
a downstream controller logic, wherein the downstream controller logic implements a configuration by routing communications between the upstream ports and the downstream ports.

3. The apparatus of claim 1, wherein the USB switching hub is configured to electronically switch between two or more configurations in response to a control signal.

4. The apparatus of claim 3, wherein the control signal originates from a device coupled to one of the upstream ports.

5. The apparatus of claim 3, wherein the control signal originates from logic internal to the USB switching hub.

6. The apparatus of claim 1, wherein the USB switching hub is configured to allow simultaneous access of separate downstream ports through separate upstream ports.

7. The apparatus of claim 1, wherein at least one configuration of the USB switching hub is hardwired or implemented through software.

8. The apparatus of claim 1, further comprising a memory coupled to the USB switching hub, wherein the memory stores a configuration.

9. The apparatus of claim 8, wherein the memory is coupled to a hub controller in the USB switching hub.

10. The apparatus of claim 1, wherein the USB switching hub further comprises a translation translator circuitry.

11. The apparatus of claim 1, wherein at least one of the downstream ports is coupled to a universal serial bus USB device.

12. The apparatus of claim 1, further comprising a computer system coupled to at least one upstream port.

13. The apparatus of claim 1, further comprising a dual role peripheral device coupled to at least one upstream port.

14. The apparatus of claim 1, further comprising a printer with a host controller coupled to at least one upstream port.

15. The apparatus of claim 1, further comprising an interface between a peripheral device and at least one of the downstream ports, wherein the interface converts a signal from the peripheral device into a binary signal.

16. The apparatus of claim 1, wherein the USB switching hub further comprises a hub controller.

17. A USB switching hub, comprising:
a first upstream port;
a second upstream port;
a plurality of downstream ports;
a downstream routing controller;
wherein the downstream routing controller is configured to implement a first configuration allowing access between the first upstream port and a first subset of the downstream ports and the second upstream port and a second subset of the downstream ports;
wherein the downstream routing controller is further configured to switch to a second configuration allowing access between the first upstream port and a third subset of downstream ports and the second upstream port and a fourth subset of the downstream ports.

18. The USB switching hub of claim 17, wherein the USB switching hub allows a first device coupled to the first upstream port to access a first downstream port at the same time the USB switching hub allows a second device coupled to the second upstream port to access a second downstream port.

19. The USB switching hub of claim 17, wherein an external signal signals the downstream routing controller to switch between the first configuration and the second configuration.

20. The USB switching hub of claim 17, further comprising a hub controller.

21. The USB switching hub of claim 17, further comprising transaction translator circuitry.

22. The USB switching hub of claim 20, wherein the transaction translator circuitry allows communication between the first upstream port and one of the plurality of downstream ports to occur at a first speed and communication between the second upstream port and a second one of the plurality of downstream ports to occur at a second speed.

23. The USB switching hub of claim 17, wherein at least one of the plurality of downstream ports is coupled to a universal serial bus (USB) 2.0 device.

24. The USB switching hub of claim 17, further comprising a computer system coupled to the first upstream port or the second upstream port.

25. The USB switching hub of claim 17, further comprising a dual role peripheral device coupled to the first upstream port or the second upstream port.

26. The USB switching hub of claim 17, further comprising a printer with a host controller coupled to the first upstream port or the second upstream port.

27. The USB switching hub of claim 17, further comprising an interface between a peripheral device and at least one of the plurality of downstream ports, wherein the interface converts a signal from the peripheral device into a binary signal.

28. The USB switching hub of claim 17, wherein the first configuration and the second configuration are hardwired.

29. The USB switching hub of claim 17, further comprising a memory coupled to the downstream routing controller, wherein the memory stores the first configuration and the second configuration.

30. The USB switching hub of claim 29, wherein the downstream routing controller accesses the memory to implement the first configuration or the second configuration.

31. A method for determining access to a first downstream peripheral device coupled to a USB switching hub, comprising:
receiving a signal to switch between a first configuration and a second configuration;
switching between the first configuration and the second configuration, wherein switching between the first configuration and the second configuration comprises switching access of the first downstream peripheral device from a first upstream port to a second upstream port; and
allowing communication between the second upstream port and the first downstream peripheral device;
wherein communication between a second downstream peripheral device and the first upstream port continues while the second upstream port accesses the first downstream port.

32. The method of claim 31, wherein the signal is an external signal from a USB upstream device coupled to the first upstream port or the second upstream port.

33. The method of claim 31, wherein a plurality of peripheral devices are coupled to the USB switching hub, and wherein switching configurations comprises switching access of a subset of the peripheral devices coupled to the USB switching hub.

34. The method of claim 31, further comprising:
terminating communications between the first downstream peripheral device and a first device coupled to the first upstream port;
electrically connecting a second device coupled to the second upstream port and the first downstream peripheral device.

35. The method of claim 34, further comprising:
enumerating the first downstream peripheral device.
communicating between the first downstream peripheral device and the second device coupled to the second upstream port.
